(19) United States
(12) Patent Application Publication
(10) Pub. No.: US 2026/0185718 A1
(43) Pub. Date: Jul. 2, 2026

(54) COOKING APPLIANCE AND METHOD FOR CONTROLLING A COOKING APPLIANCE

(71) Applicant: LG ELECTRONICS INC., Seoul (KR)

(72) Inventors: Gyeongmin KIM, Seoul (KR); Hyun Woo PARK, Seoul (KR); Doo Hyun KIM, Seoul (KR)

(21) Appl. No.: 19/426,203

(22) Filed: Dec. 19, 2025

(30) Foreign Application Priority Data
Dec. 26, 2024 (KR) 10-2024-0197507

(51) Int. Cl. F24C 14/02; F24C 15/32

(52) U.S. Cl. CPC F24C 14/02; F24C 15/322

(57) ABSTRACT

A cooking appliance and a method for controlling a cooking appliance are provided. The cooking appliance and method may include, in response to selection of a self-cleaning operation, a first heating operation of driving a broil heater and a fan, and a second heating operation of driving a convection heater and the fan. A rotational speed of the fan in the first heating operation and a rotational speed of the fan in the second heating operation may be the same.

### CROSS-REFERENCE TO RELATED APPLICATION(S)

This application claims priority under 35 U.S.C. §119 to Korean Application No. 10-2024-0197507, filed in Korea on December 26, 2024, whose entire disclosure is hereby incorporated by reference.

### BACKGROUND

### 1. Field

A cooking appliance, and a method for controlling a cooking appliance are disclosed herein.

### 2. Background

A cooking appliance is a home appliance for cooking food or other items (hereinafter collectively “food”), and is an appliance installed in a kitchen area and used for cooking food according to the user’s intention. Such cooking appliances may be classified in various ways depending on a heat source, shape, and type of fuel used, for example.

In classifying cooking appliances based on a way of cooking, they can be classified into open-type and closed-type cooking appliances, depending on the type of space where food is placed. Closed-type cooking appliances include ovens, and microwave ovens, for example, while open-type cooking appliances include cooktops, hobs, and griddles, for example.

A closed-type cooking appliance is a cooking appliance that seals the space in which food is placed and heats the sealed space to cook the food. A closed-type cooking appliance is provided with a cooking chamber, which is a space in which food is placed and that is sealed when the food is to be cooked. This cooking chamber serves as the space where the food is actually cooked.

A closed-type cooking appliance is pivotally provided with a door that selectively opens and closes the cooking chamber. The door is pivotally installed on a main body, which has the cooking chamber formed therein, via a door hinge provided between the main body and the door. This door may selectively open and close the cooking chamber by pivoting around a portion coupled with the main body via the door hinge.

A heat source is provided in the interior space of the cooking chamber, which is opened and closed by the door, and heats the cooking chamber. A gas burner, or an electric heater, for example, may be used as such a heat source.

Further, when heating and cooking meat or food containing meat using the closed-type cooking appliance as described above, lipids, such as fats or oils, from the food float inside the cooking chamber and stick to wall surfaces of the cooking chamber, contaminating the interior walls of the cooking chamber. The lipids stuck (adhered) to the wall surfaces of the cooking chamber in this way undergo so-called polymerization, and are firmly fixed, thereby turning into a state that is challenging to clean (remove).

Some of the cooking appliances released recently are equipped with a self-cleaning function that automatically removes contaminants, such as lipids as described above, for example. The self-cleaning function of cooking appliances is a function of automatically removing contaminants, such as lipids, for example, stuck (adhered) to the wall surfaces of the cooking chamber.

Self-cleaning in cooking appliances is primarily performed using a thermal decomposition method known as so-called pyrolysis, which burns and removes contaminants, by heating the interior of the cooking chamber with a heat source, such as a burner or heater, and allowing the temperature inside of the cooking chamber to remain at a high temperature for an extended period when contaminants, such as lipids, adhere to the wall surfaces of the cooking chamber. According to the self-cleaning performed as described above, poor results of removing contaminants are typically seen at a front side of the cooking chamber where the door is located. In other words, good contaminant removal is seen in portions adjacent to the heat source and convection device, whereas relatively poor contaminant removal is seen in a front region of the cooking chamber, which is farther from the heat source and convection device. This is because a heat flow due to operation of the convection device fails to properly reach the front region of the cooking chamber, preventing a temperature of the wall surface in that portion from reaching a temperature that allows for cleaning.

Therefore, there is a need for a design for operation of a heat source and a convection device to enable a state of the front region of the cooking chamber to be changed to a state that allows for cleaning.

### BRIEF DESCRIPTION OF THE DRAWINGS

Embodiments will be described in detail with reference to the following drawings in which like reference numerals refer to like elements, and wherein:

FIG. 1 is a perspective view of a cooking appliance in accordance with an embodiment;

FIG. 2 is a front view showing a door open state of the cooking appliance of FIG. 1;

FIG. 3 is a side cross-sectional view showing internal structure of the cooking appliance of FIG. 1;

FIG. 4 is a side cross-sectional view showing structure of a convection device of FIG. 3;

FIGS. 5 and 6 are front cross-sectional views schematically showing a pattern of hot air flows within the cooking chamber;

FIGS. 7 and 8 are side cross-sectional views schematically showing the pattern of hot air flows within the cooking chamber;

FIG. 9 is a schematic diagram showing a configuration of a cooking appliance in accordance with an embodiment;

FIG. 10 is a flowchart of a control process of a cooking appliance in accordance with an embodiment;

FIG. 11 is a schematic diagram showing a driving control state in accordance with a method for controlling a cooking appliance illustrated in FIG. 10;

FIG. 12 is a schematic diagram showing a region to be primarily heated when performing a first heating operation;

FIG. 13 is a schematic diagram showing a region to be primarily heated when performing a second heating operation; and

FIG. 14 is a schematic diagram showing a driving control state of a conventional cooking appliance.

### DETAILED DESCRIPTION

Objectives, features, and advantages will be described with reference to accompanying drawings, and accordingly, those having ordinary skill in the art to which embodiments pertain will be able to readily embody the technical ideas. In describing the embodiments, if specific descriptions of known technologies related to the embodiments are deemed to unnecessarily obscure the gist, the descriptions thereof have been omitted. Hereinafter, embodiments will be described with reference to the accompanying drawings. In the drawings, the same or like reference numerals are used to indicate identical or similar components.

Although terms such as “first,” “second,” etc., are used to describe various components, these components are not limited by such terms, as a matter of course. These terms are used merely to distinguish one component from another, and surely, a first component may also be a second component, unless otherwise specified.

The embodiments are not limited to the embodiments disclosed hereinafter, but may be modified in various ways and implemented in a variety of different forms. The embodiments are provided solely to ensure the disclosure is complete and to fully inform those skilled in the art of the scope. Therefore, it should be understood that the embodiments are not limited to the embodiments disclosed below, but include not only substituting or adding the configuration of one embodiment to that of another embodiment, but also all modifications, equivalents, and alternatives that fall within the technical ideas and scope.

The accompanying drawings are merely intended to facilitate understanding of the embodiments disclosed herein; the technical ideas disclosed herein are not limited by the accompanying drawings, and it should be understood that they encompass all modifications, equivalents, and alternatives falling within the spirit and technical scope. The components in the drawings may be exaggerated or reduced in size or thickness in light of ease of understanding for example; however, this should not be construed as limiting the scope of protection.

The terms used herein are used only to describe particular implementations or embodiments and are not intended to limit the present disclosure. Further, singular expressions include plural expressions, unless the context explicitly dictates otherwise. Terms such as “include” and “consist of” herein are intended to specify the presence of features, numbers, steps, operations, components, parts, or combinations thereof described herein. In other words, it should be understood that terms such as “include” and “consist of” herein do not preclude the possibility of the presence or addition of one or more other features, numbers, steps, operations, components, parts, or combinations thereof.

Terms containing ordinal numbers, such as “first,” “second,” and the like, may be used to describe various components, but these components are not limited by such terms. These terms are used solely for the purpose of distinguishing one component from another.

When a component is said to be “connected” or “coupled” to another component, it is to be understood that it may be directly connected or coupled to said another component, but that other components may also be present in between. In contrast, when a component is said to be “directly connected” or “directly coupled” to another component, it is to be understood that there are no other components present in between.

When a component is said to be “on” or “under” another component, it is to be understood that it may not only be positioned directly on or under said another component, but that other components may also be present in between.

Unless otherwise defined, all terms used herein, including technical or scientific terms, have the same meaning as commonly understood by those having ordinary skill in the art to which the disclosure pertains. Terms such as those defined in commonly used dictionaries should be interpreted as having a meaning consistent with their meaning in the context of the relevant art, and shall not be construed in an idealized or overly formal sense unless explicitly defined in the present application.

In a state in which a cooking appliance is placed on a floor, a direction in which a door is installed relative to a center of the cooking appliance is defined as a forward direction. Therefore, the direction toward an interior of the cooking appliance with the door open becomes a rearward direction. For convenience, these forward and rearward directions may be referred to as a first direction. Then, the forward direction may be referred to as one direction of the first direction, and the rearward direction may be referred to as the other direction of the first direction.

In addition, the gravitational direction may be defined as a downward direction. The direction opposite to the gravitational direction may be defined as an upward direction.

Further, a horizontal direction perpendicular to the frontward-rearward direction of the cooking appliance, that is, a widthwise direction of the cooking appliance when viewing the cooking appliance from a front of the door of the cooking appliance, may be referred to as a leftward-rightward direction. For convenience, the leftward-rightward direction may be referred to as a second direction. Then, a right side may be referred to as one direction of the second direction, and a left side may be referred to as the other direction of the second direction.

Moreover, the widthwise direction of the cooking appliance may also be referred to as a lateral direction. Then, the right side may be referred to as one side of the lateral direction, and the left side may be referred to as the other side of the lateral direction.

In addition, an upward-downward direction may be referred to as a third direction. Then, the upward direction may be referred to as one direction of the third direction, and the downward direction may be referred to as the other direction of the third direction.

Further, the upward-downward direction described above may be referred to as a vertical direction. Then, the frontward-rearward direction and the leftward-rightward direction, that is, the first direction and the second direction, may be referred to as the horizontal direction.

Hereinafter, “A and/or B” denotes A, B, or A and B, unless otherwise specified, and “C to D” denotes C or greater and D or less, unless otherwise specified.

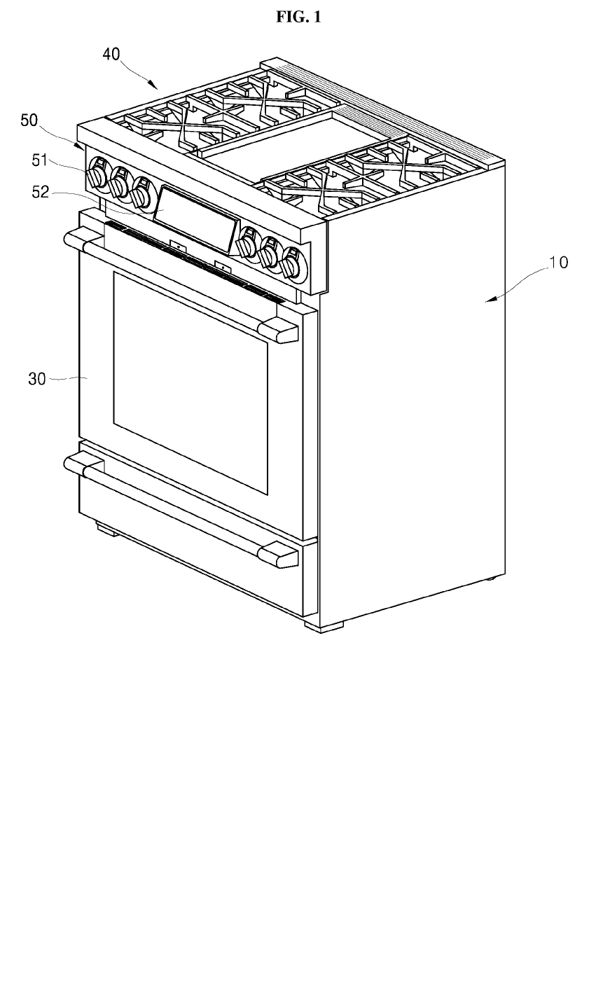

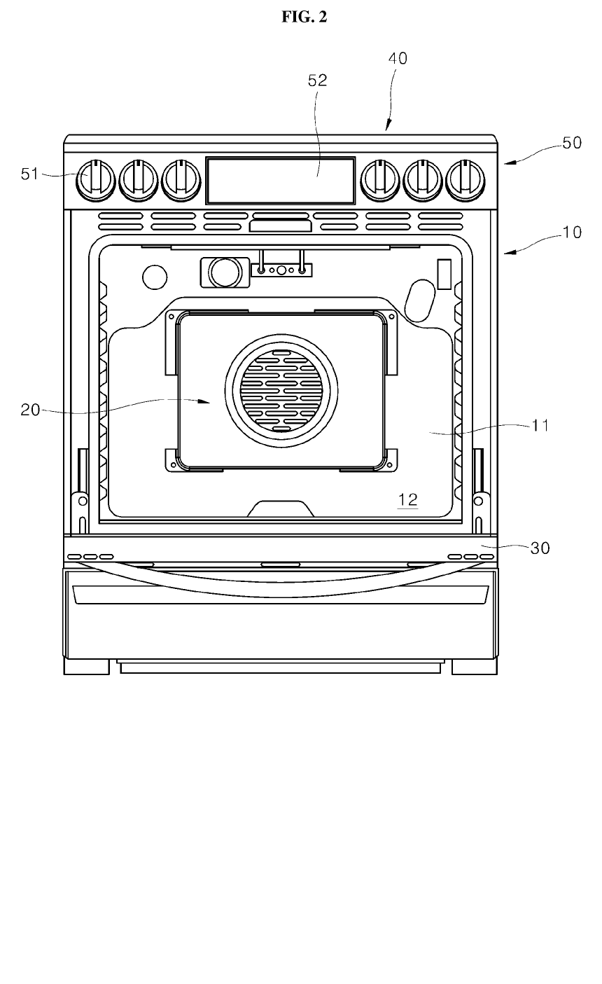

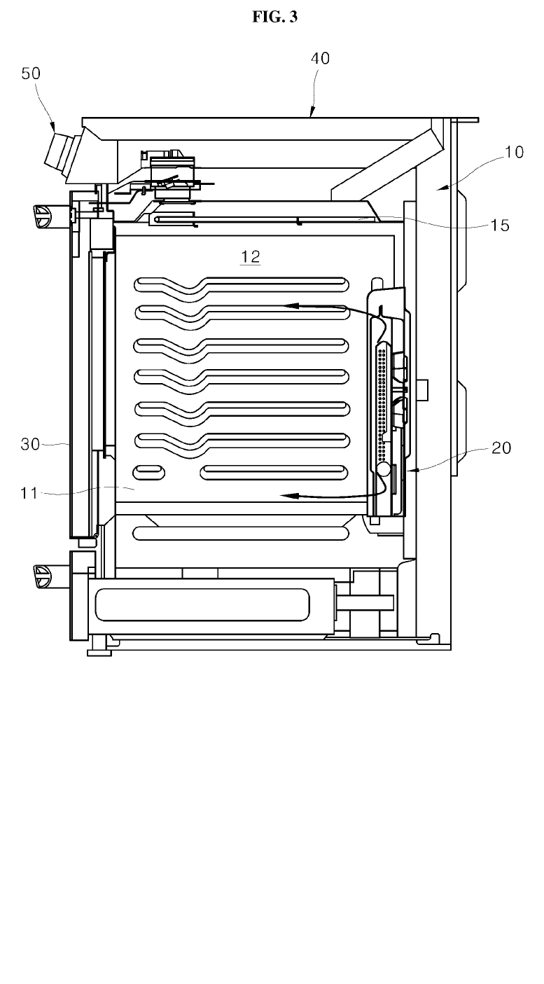

FIG. 1 is a perspective view of a cooking appliance according to an embodiment. FIG. 2 is a view showing a door open state of the cooking appliance shown in FIG. 1. FIG. 3 is a side cross-sectional view showing internal structure of the cooking appliance of FIG. 1.

Referring to FIGS. 1 to 3, the cooking appliance may have an exterior thereof formed by a main body 10. The main body 10 may be provided in a form that includes a roughly rectangular prism shape, for example, and may be formed from a material having a predetermined strength in order to protect multiple components installed in an interior space thereof.

The main body 10 may include a cavity 11 that forms a framework of the main body 10. The cavity 11 may be formed in a shape of a hexahedron with a front open, and a cooking chamber 12 may be provided inside of the cavity 11. In other words, the cooking chamber 12 may be formed as a roughly hexahedral space disposed inside of the cavity 11 and may be formed as a space open toward the front.

When the cooking chamber 12 is sealed, food may be cooked while the interior of the cooking chamber 12 is heated. In other words, in the cooking appliance according to an embodiment provided as a closed-type cooking appliance, the cooking chamber 12 is a space in which food is actually cooked.

The cooking appliance is provided with a heating device that heats the cooking chamber 12. The heating device may be provided as a burner using gas fuel or a heater using electricity, for example. As such, the structure of the heating device may be modified depending on the type of heat source used.

For example, the heating device may include a convection device 20 disposed at a rear side of the cooking chamber 12. The convection device 20 ensures the interior space of the cooking chamber 12 is heated uniformly by blowing air while drawing in air from inside of the cooking chamber 12, heating it, and then discharging it back into the cooking chamber 12.

In addition, the heating device may also include a broil burner or broil heater or broiler 15, for example. The broil burner or broil heater 15 may be disposed at an upper portion of the cooking chamber 12 and heat the interior space of the cooking chamber 12 from the upper portion of the cooking chamber 12.

The cooking appliance may be pivotally provided with a door 30 that selectively opens and closes the cooking chamber 12. For example, the door 30 may be provided in the form of opening and closing the cooking chamber 12 in a pull-down manner in which an upper end thereof pivots up and down around a lower end thereof.

A cooktop unit 40, which is provided to heat food or a container holding food to thereby cook the food, may be disposed at the upper portion of the main body 10. The cooktop unit 40 may be provided with a top plate that closes an upper end of the main body 10 while forming an exterior of a top surface thereof.

A central portion of the cooktop unit 40 may be provided with at least one or more heating units for heating food or a container holding the food to be cooked. For example, the heating unit may be provided as a heating device that uses gas fuel.

For example, the heating unit may be provided as an induction heater that uses electricity. As such, the structure of the heating unit may be modified depending on the type of heat source used.

An upper portion of a front surface of the cooking appliance, that is, an upper front surface of the cavity 11 may be provided with a control panel 50. The control panel 50 may form a portion of an exterior of a front surface of the cooking appliance. This control panel 50 may be provided with knobs 51 that adjust an operation of the cooking appliance, and a display 52 that displays an operating status of the cooking appliance, for example.

The interior space of the main body 10, that is, the space between the cooktop unit 40 and the cooking chamber 12, may be provided with an electrical component compartment, which provides a space in which electrical components are located. The electrical component compartment may be the space formed between the cooktop unit 40 and the cooking chamber 12, or may be a conceptual space obtained by combining the space formed between the cooktop unit 40 and the cooking chamber 12 and a space inside of the cooktop unit 40. A front surface of the electrical component compartment may be covered by the control panel 50 or by the door 30.

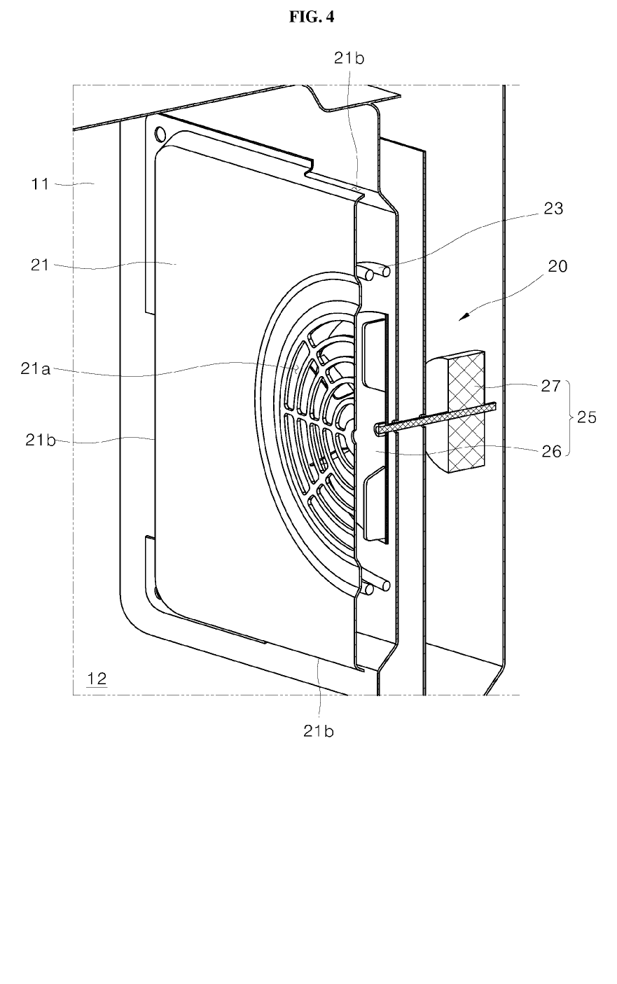

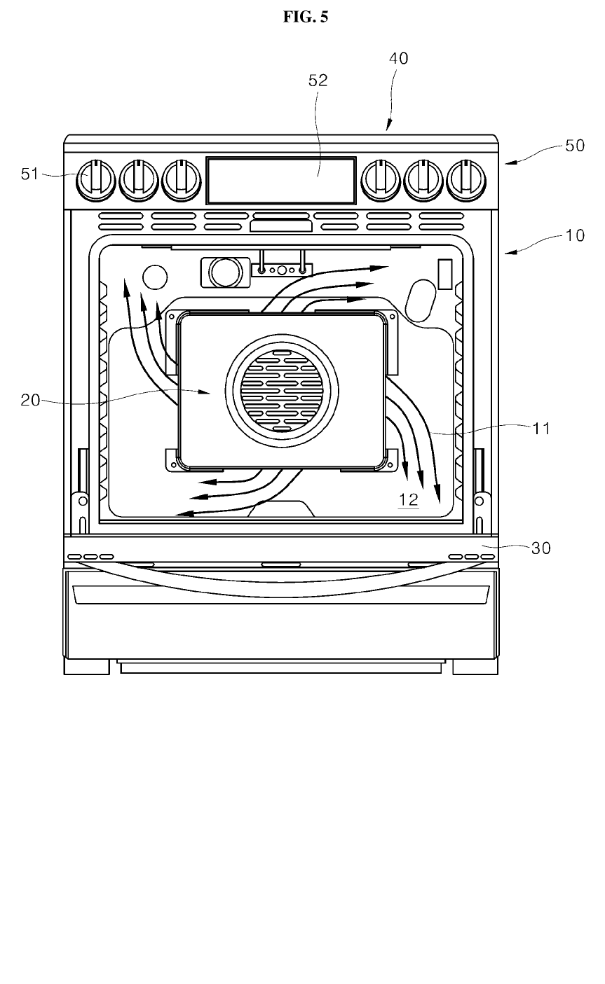

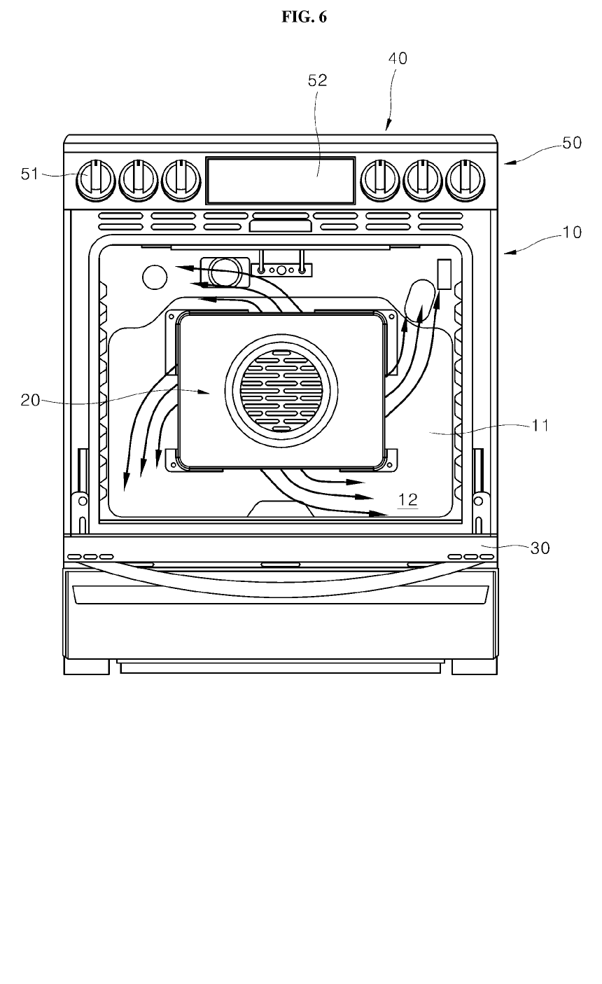

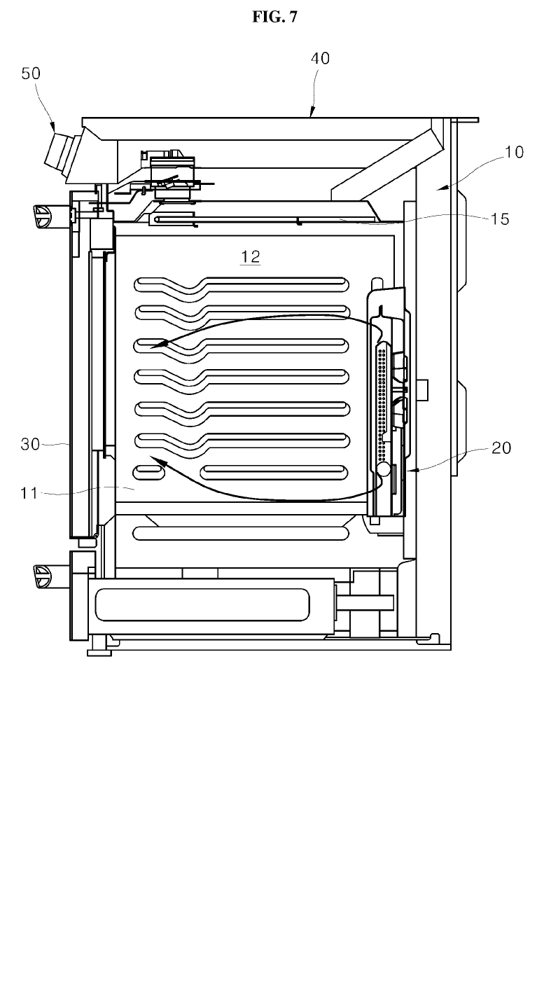

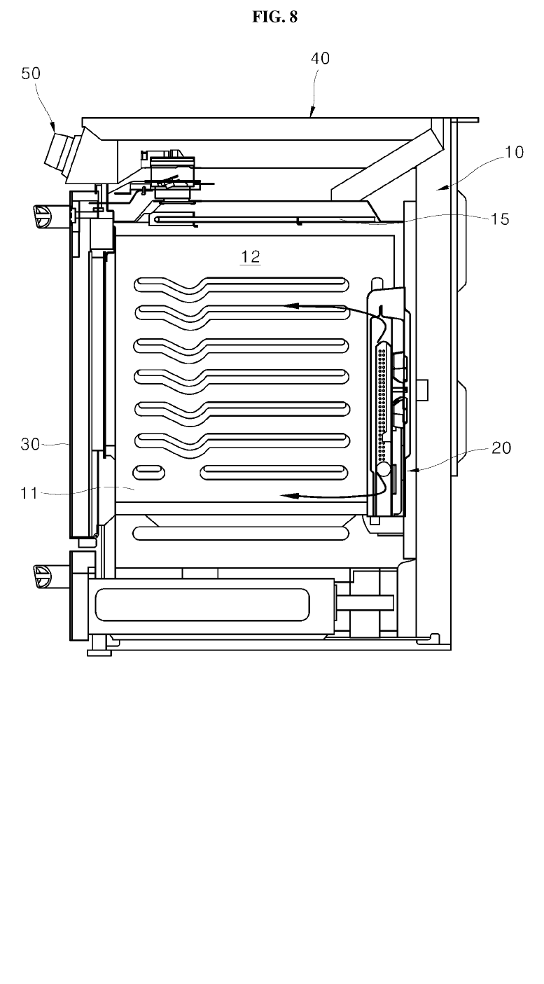

FIG. 4 is a side cross-sectional view showing structure of a convection device of FIG. 3. FIGS. 5 and 6 are front cross-sectional views schematically showing a pattern of hot air flows within the cooking chamber, and FIGS. 7 and 8 are side cross-sectional views schematically showing the pattern of hot air flows within the cooking chamber.

As shown in FIGS. 3 to 4, the cooking appliance according to an embodiment may include a heating device for heating the interior of the cooking chamber 12. For example, the heating device may include the broil heater 15 and the convection device 20.

The broil heater 15 may be installed on one surface of the cavity 11 and disposed inside of the cooking chamber 12. For example, the broil heater 15 may be installed on a top surface of the cavity 11 and disposed at the upper portion of the cooking chamber 12.

The broil heater 15 may heat the interior of the cooking chamber 12 from the upper portion of the cooking chamber 12. In other words, the broil heater 15 may be provided to apply heat directly to food from the upper portion of the cooking chamber 12.

The convection device 20 may be installed on a surface of the cavity 11 other than the surface on which the broil heater 15 is installed, and may be disposed inside or outside of the cooking chamber 12. For example, the convection device 20 may be installed on a rear surface of the cavity 11 and disposed at a rear side of the cooking chamber 12. The convection device 20 may include a fan cover 21, a convection heater 23, and a fan module 25.

The fan cover 21 may be disposed at a side of the cooking chamber 12 adjacent to the rear surface of the cavity 11 and may be installed on the rear surface of the cavity 11. The fan cover 21 may form a space, which is separated from the cooking chamber 12, inside of the convection device 20.

For example, the fan cover 21 may be formed in a hexahedral shape, with a front surface thereof facing the door 30 and side surfaces thereof facing side surfaces of the cavity 11. An intake port 21a may be disposed at a center of a front surface of the fan cover 21, and air inside of the cooking chamber 12 may flow into an interior space of the convection device 20 through the intake port 21a.

The convection heater 23 and the fan module 25 may be disposed in an interior space of the convection device 20 formed by the fan cover 21. The convection heater 23 and the fan module 25 disposed in this way may be installed on the rear surface of the cavity 11.

The convection heater 23 may be configured to heat air introduced into the interior space of the convection device 20. The convection heater 23 may be provided as a heater that uses electricity or as a burner that uses gas fuel, for example.

The air heated by the convection heater 23 in the interior space of the convection device 20 may be discharged into the cooking chamber 12 by the fan module 25. In other words, hot air may be generated in the interior space of the convection device 20 by the convection heater 23 and the fan module 25, and this hot air may be discharged into the cooking chamber 12 through discharge ports 21b.

The discharge ports 21b may be provided on the fan cover 21, and may be disposed on at least one of side, top, or bottom surfaces of the fan cover 21. In this embodiment, the discharge ports 21b are shown as being disposed on both side surfaces, the top surface, and the bottom surface of the fan cover 21, respectively.

Each discharge port 21b may be formed in the shape of penetrating the side, top, or bottom surface of the fan cover 21. The hot air generated inside of the convection device 20 may be discharged into the cooking chamber 12 through the discharge ports 21b.

The fan module 25 may be disposed in the interior space of the convection device 20 surrounded by the fan cover 21, and may be configured to be rotatable around a frontward-rearward direction rotational shaft 26c. The rotational shaft of the fan module 25 may be disposed at a position at which it overlaps in the frontward-rearward direction with the intake port 21a disposed approximately at the center of the fan cover 21.

The fan module 25 may draw in air from the cooking chamber 12 into the interior space of the convection device 20 through the intake port 21a, and discharge air heated in the interior space of the convection device 20 into the cooking chamber 12 through the discharge ports 21b. For example, the fan module 25 may generate a flow of hot air that moves backward toward the interior space of the convection device 20 in the cooking chamber 12 and moves in a centrifugal direction in the interior space of the convection device 20. The fan module 25 may include a fan 26 and a fan motor 27.

The fan 26 may be configured to rotate around the frontward-rearward direction rotational shaft 26c to thereby generate hot air. For example, the fan 26 may include a plate 26a and blades 26b.

The plate 26a may be coupled with the rotational shaft 26c rotated by the fan motor 27 and may rotate around the rotational shaft 26c. For example, the plate 26a may be formed in a circular plate shape with the rotational shaft 26c coupled to its center.

The blades 26b may be formed to protrude forward from the plate 26a. For example, a plurality of blades 26b may be arranged radially around the rotational shaft 26c, and these blades 26b may rotate together with the plate 26a.

The fan module 25 may be configured to adjust a rotational direction of the fan 26. The fan module 25 may be configured to rotate the fan 26 in both directions around the frontward-rearward directional rotational shaft 26c. For example, the fan module 25 may be configured to rotate the fan 26 in forward or reverse directions as needed.

According to this embodiment, when the fan 26 rotates in the forward direction, the fan 26 may blow hot air in a direction between the forward direction and the centrifugal direction (see FIG. 5). Further, when the fan 26 rotates in the reverse direction, the fan 26 may blow hot air in a direction between the reverse direction and the centrifugal direction (see FIG. 6).

For example, assuming that the cooking chamber 12 is divided into four regions when viewed from the front, that is, assuming that the cooking chamber 12 is divided into a left or first upper region 12a, a left or first lower region 12b, a right or second upper region 12d, and a right or second lower region 12c, a main flow of hot air generated by the fan 26 rotating in the forward direction may primarily flow toward the left upper region 12a and the right lower region 12c (see FIG. 5). Further, a main flow of hot air generated by the fan 26 rotating in the reverse direction may primarily flow toward the left lower region 12b and the right upper region 12d (see FIG. 6).

In addition, the fan module 25 may be configured to adjust a rotational speed of the fan 26. For example, the rotational speed of the fan 26 may be adjusted by adjusting an output of the fan motor 27. For example, a brushless DC (BLDC) motor may be applied as the fan motor 27. In other words, the fan module 25 may include a BLDC motor configured to rotate the fan 26 in forward and reverse directions at two or more speeds.

The rotational speed of the fan 26 may affect a travel distance of the hot air discharged from the inside of the convection device 20 into the cooking chamber 12. For example, as the rotational speed of the fan 26 increases, the hot air may travel farther forward (see FIG. 7), and as the rotational speed of the fan 26 decreases, the hot air may travel a shorter distance forward (see FIG. 8). In other words, the main flow of hot air may flow quickly to a location closer to the door 30 as the rotational speed of the fan 26 increases (see FIG. 7), and may flow primarily toward a rather rear region of the cooking chamber 12 as the rotational speed of the fan 26 decreases (see FIG. 8).

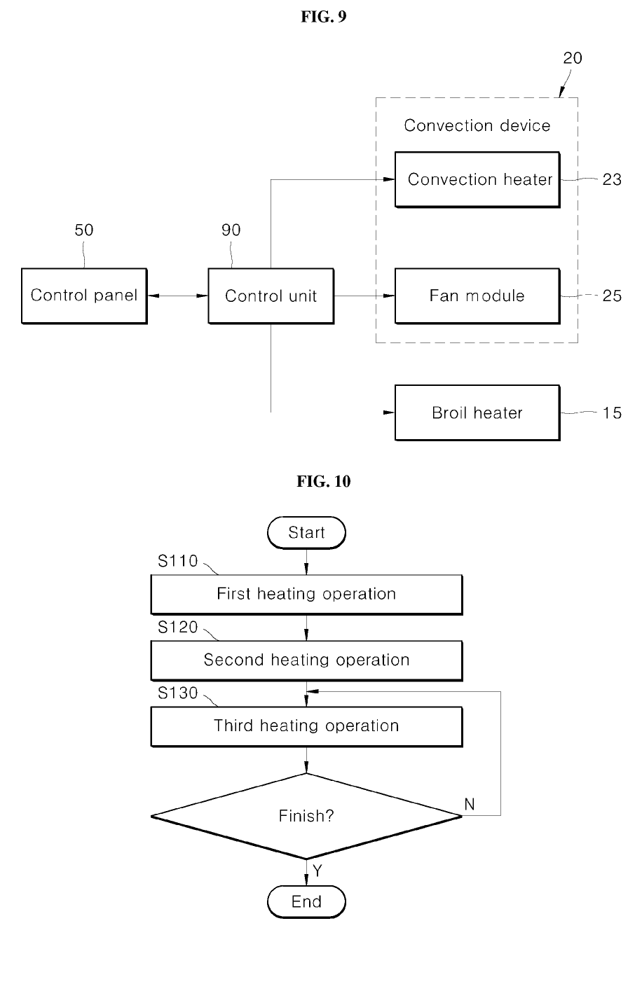

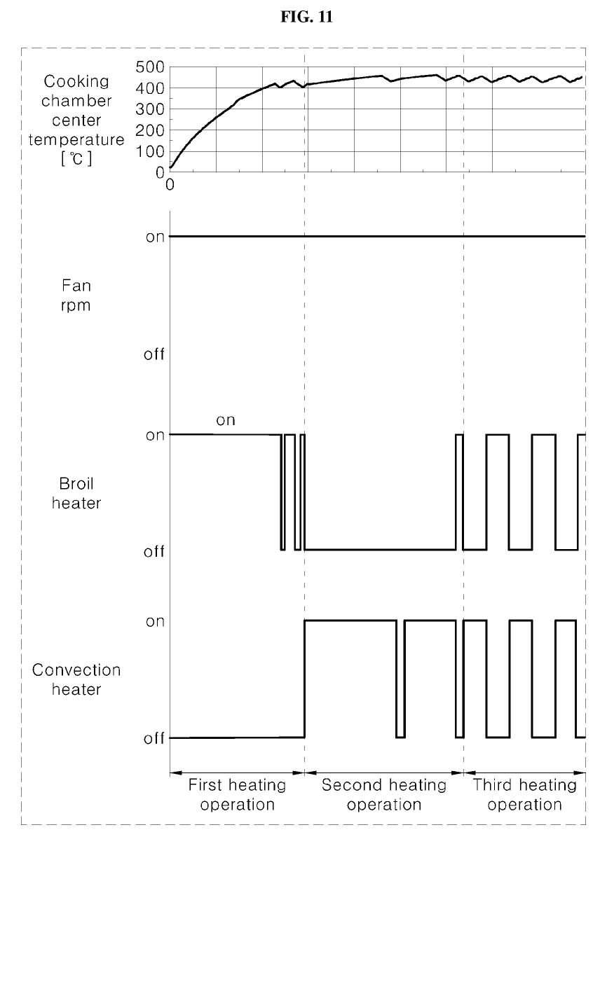

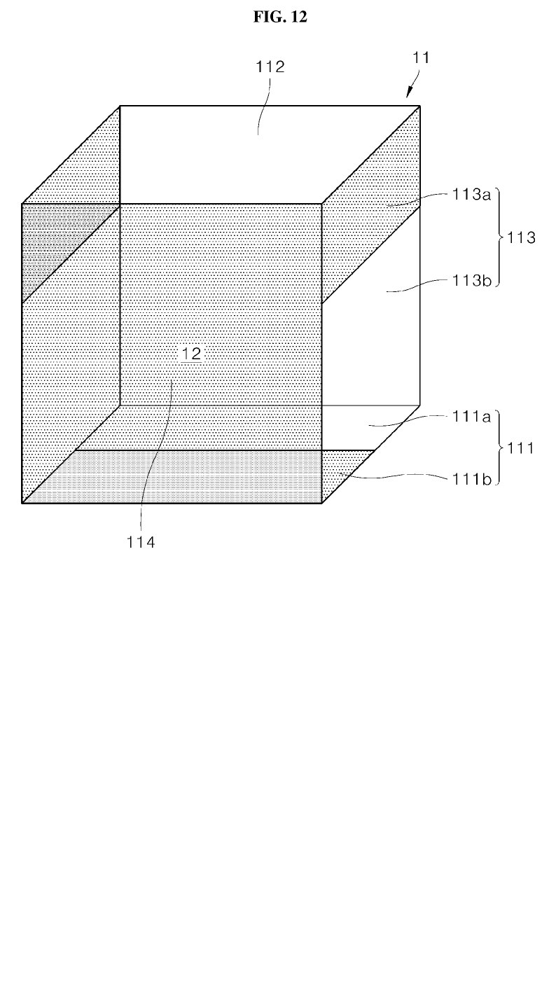

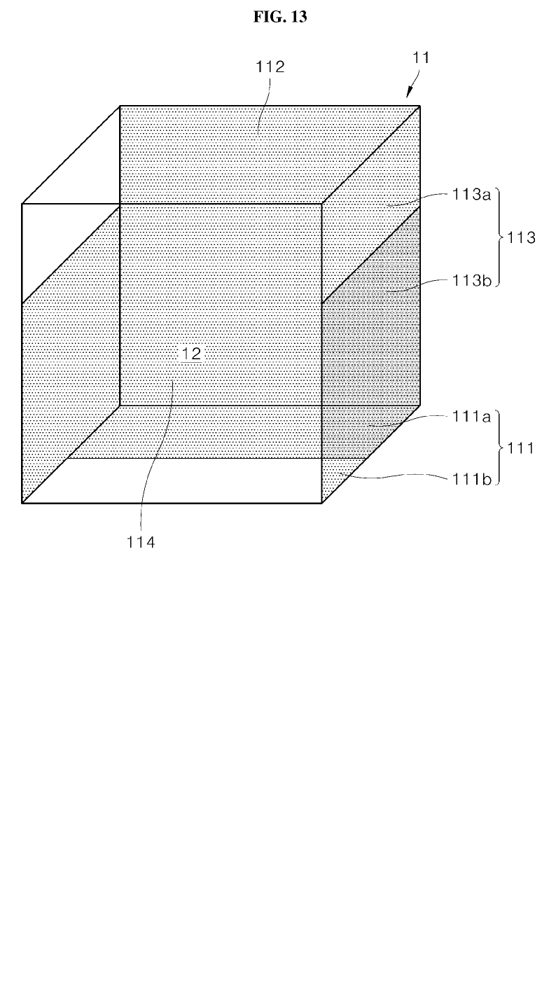

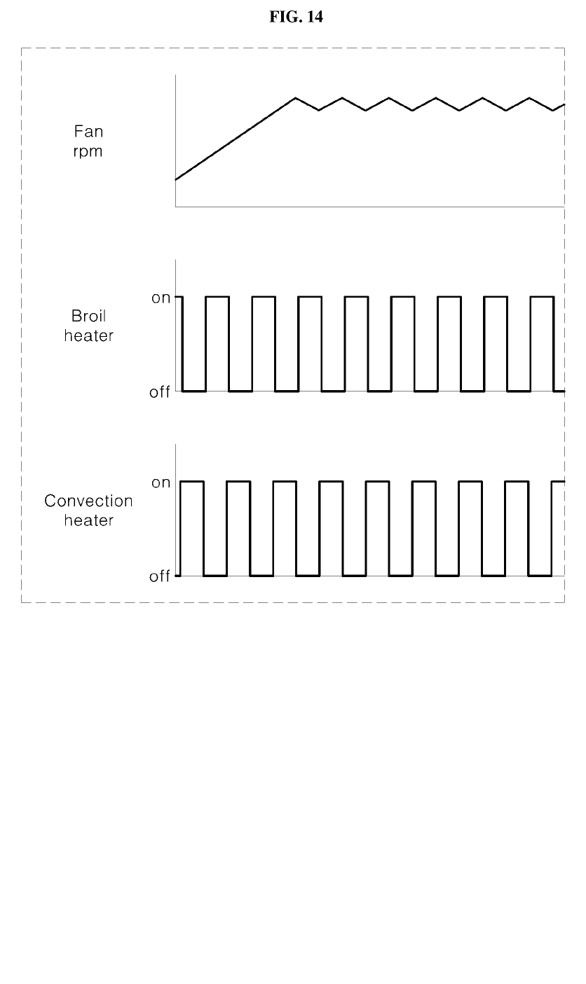

FIG. 9 is a schematic diagram showing a configuration of a cooking appliance according to an embodiment. FIG. 10 is a flowchart of a control process of a cooking appliance according to an embodiment. FIG. 11 is a schematic diagram showing a driving control state in accordance with a method for controlling a cooking appliance illustrated in FIG. 10. FIG. 12 is a schematic diagram showing a region to be primarily heated when performing a first heating operation. FIG. 13 is a schematic diagram showing a region to be primarily heated when performing a second heating operation. FIG. 14 is a schematic diagram showing a driving control state of a conventional cooking appliance.

Referring to FIGS. 3, 4, and 9, the cooking appliance according to an embodiment may include a control unit 90. The control unit 90 may be provided to control the operation of the cooking appliance. For example, the control unit 90 may control the operation of heating devices, such as the broil heater 15, and the convection device 20, for example, according to input signals input via the knobs 51, and switches, for example, provided on the control panel 50.

For example, the control unit 90 may control the operation of the broil heater 15 and the convection heater 23, and may control the operation of the fan module 25 as well. For example, the control unit 90 may control the operation of the convection heater 23 in a manner of adjusting an on/off state of the convection heater 23. Further, the control unit 90 may control the operation of the fan module 25 so as to be able to perform at least one of an operation of changing the rotational direction of the fan 26 or an operation of changing the rotational speed of the fan 26. This control unit 90 may adjust the rotational direction of the fan 26 by adjusting a driving direction of the fan motor 27, and may also adjust the rotational speed of the fan 26 by adjusting an output of the fan motor 27.

The user may select a cooking mode by operating knobs 51, or switches, for example, provided on the control panel 50. When one of a variety of cooking modes is selected, the cooking appliance may operate the heating device in order to provide a cooking function in accordance with the selected cooking mode.

According to embodiments disclosed herein, the cooking appliance may provide a self-cleaning function. The self-cleaning function is a function that makes it possible to burn and remove contaminants by heating the interior of the cooking chamber 12 with the heating unit and allowing the temperature inside of the cooking chamber 12 to be maintained at a high temperature for an extended period. In the process of implementing the self-cleaning function, the control unit 90 may control the operation of the heating devices, such as the broil heater 15, and the convection device 20, for example.

As one example thereof, as shown in FIGS. 4 and 9 to 11, when the user selects an operating mode for implementing the self-cleaning function by operating the knobs 51, or switches, for example, provided on the control panel 50, the cooking appliance may first perform a first heating operation (S110). When the cooking appliance performs the first heating operation, the control unit 90 may drive the broil heater 15 and the fan 26. In other words, when the first heating operation begins, the operation of the broil heater 15 and the fan 26 may begin.

The first heating operation may be performed for a first set or predetermined time (period of time). While the first heating operation is performed, the interior space of the cooking chamber 12 and each wall surface of the cavity 11 may be heated by heat emitted from the broil heater 15.

In addition, while the first heating operation is performed, the fan 26 may blow hot air while rotating, and the hot air blown by the operation of the fan 26 may flow inside of the cooking chamber 12. The hot air flowing inside of the cooking chamber 12 in this way may serve to ensure that the heat emitted from the broil heater 15 may be transferred to all regions of the cooking chamber 12.

In this embodiment, an output of the broil heater 15 is exemplified as being higher than an output of the convection heater 23. In other words, an amount of heat per unit time supplied by the broil heater 15 to the cooking chamber 12 is exemplified as being higher than an amount of heat per unit time supplied by the convection heater 23 to the cooking chamber 12. For example, the output of the broil heater 15 may be 3,800 W, and the output of the convection heater 23 may be 2,500 W.

For example, the broil heater 15, which may heat the cooking chamber 12 with a higher output than the convection heater 23, may be operated in the first heating operation. Accordingly, the temperature of the cooking chamber 12 may be quickly raised to the temperature required for performing self-cleaning.

In addition, according to this embodiment, the broil heater 15 may be disposed further forward than the convection heater 23. Accordingly, the first heating operation may heat the cooking chamber 12 in the form of concentrating a high amount of heat on a rather forward region of the cooking chamber 12.

Along therewith, the fan 26 may rotate at a set or predetermined speed and generate hot air, thereby allowing the heat emitted from the broil heater 15 to be transferred to all of the regions by the hot air. For example, the set or predetermined speed may be a rotational speed of the fan 26 that allows a main flow of hot air generated by the fan 26 to be concentrated on the front region of the cooking chamber 12 adjacent to the door 30. For example, the set or predetermined speed may be 2,000 to 2,400 rpm.

As the broil heater 15 and the fan 26 are driven as described above, a significant portion of the heat supplied into the cooking chamber 12 by the broil heater 15 may be supplied intensively to the front region of the cooking chamber 12 adjacent to the door 30. For example, when the cooking appliance performs the first heating operation, heat may be supplied intensively to an upper region 113a of a side surface 113 of the cavity 11 and its surrounding space, a front region 111b of a bottom surface 111 of the cavity 11 and its surrounding space, and an adjacent space adjacent to an open front surface 114 of the cavity 11, as shown in FIGS. 9 to 12.

The upper region 113a of the side surface 113 of the cavity 11 and its surrounding space are locations very close to the broil heater 15 installed on a top surface 112 of the cavity 11. Further, the front region of the bottom surface 111 of the cavity 11 and its surrounding space, and the space adjacent to the open front surface 114 of the cavity 11 are where the main flow of hot air generated by the fan 26 rotating at the set or predetermined speed is concentrated.

Accordingly, when the cooking appliance performs the first heating operation, heating of the upper region 113a of the side surface 113 of the cavity 11 and its surrounding space, the front region of the bottom surface 111 of the cavity 11 and its surrounding space, and the adjacent space adjacent to the open front surface 114 of the cavity 11 may be performed more predominantly than heating of the rest of the spaces. Further, in the first heating operation, the rotational speed of the fan 26 may be maintained at the set or predetermined speed. In other words, the rotational speed of the fan 26 may be maintained at the set or predetermined speed with little change while the first heating operation is performed. For example, the rotational speed of the fan 26 may be maintained at 2,100 to 2,300 rpm while the first heating operation is performed. Accordingly, while the cooking appliance performs the first heating operation, heat concentration on the front region of the cooking chamber 12 may be maintained continuously.

After the first heating operation has been performed for the first set or predetermined time, the cooking appliance may perform a second heating operation (S120). The first set or predetermined time may be set to a time required for the temperature of the cooking chamber 12 to rise to a temperature required for performing self-cleaning. For example, a first heating operation execution duration for raising the temperature of the cooking chamber to approximately 400 °C may be set to the first set or predetermined time. For example, the cooking appliance may perform the first heating operation until the temperature of the cooking chamber rises to approximately 400 °C, and then perform the second heating operation.

When the cooking appliance performs the second heating operation, the control unit 90 may drive the convection heater 23 and the fan 26. In other words, when the second heating operation begins, the operation of the convection heater 23 and the fan 26 may begin. At this time, the operation of the broil heater 15 may be suspended. This embodiment exemplifies that when the cooking appliance performs the second heating operation, the operation of the convection heater 23 and the fan 26 is performed, whereas the operation of the broil heater 15 is suspended.

The second heating operation may be performed for a second set or predetermined time (period of time). While the second heating operation is performed, the interior space of the cooking chamber 12 and each wall surface of the cavity 11 may be heated by the heat emitted from the convection heater 23.

In addition, while the second heating operation is performed, the fan 26 may blow hot air while rotating, and the hot air blown by the operation of the fan 26 may flow inside of the cooking chamber 12. The hot air flowing inside of the cooking chamber 12 in this way may serve to ensure that heat emitted from the convection heater 23 may be transferred to all regions of the cooking chamber 12.

For example, the rotational speed of the fan 26 in the second heating operation may be maintained at a set or predetermined speed. In other words, the rotational speed of the fan 26 in the first heating operation may be maintained the same as that in the second heating operation. Accordingly, a significant portion of the heat supplied into the cooking chamber 12 by the convection heater 23 may be supplied intensively to the front region of the cooking chamber 12 adjacent to the door 30.

As a result of the first heating operation being performed for the first set or predetermined time, the temperature of the cooking chamber 12 rises to the temperature required for performing self-cleaning, and heating of the upper and front regions of the cooking chamber 12 may be achieved sufficiently. In contrast, heating of the lower and rear regions of the cooking chamber 12 may have been achieved less than that of the upper and front regions of the cooking chamber 12.

When the cooking appliance performs the second heating operation, heat may be supplied intensively to the rear surface 112 of the cavity 11 and its surrounding space, the lower region 113b of the side surface 113 of the cavity 11 and its surrounding space, and the rear region 111a of the bottom surface 111 of the cavity 11 and its surrounding space. The rear surface 112 of the cavity 11 and its surrounding space are locations very close to the convection heater 23 installed on the rear surface of the cavity 11. Further, as the convection heater 23 is disposed lower than the broil heater 15, the lower region 113b of the side surface 113 of the cavity 11 and the rear region 111a of the bottom surface 111 of the cavity 11 and their surrounding spaces may also be considered locations adjacent to the convection heater 23. Accordingly, when the cooking appliance performs the second heating operation, heating of the rear surface 112 of the cavity 11 and its surrounding space, the lower region 113b of the side surface 113 of the cavity 11 and its surrounding space, and the rear region 111a of the bottom surface 111 of the cavity 11 and its surrounding space may be performed more predominantly than heating of the rest of the spaces, as shown in FIGS. 9 to 11 and FIG. 13.

Further, in the second heating operation as well, the rotational speed of the fan 26 may be maintained at a set or predetermined speed. In other words, the rotational speed of the fan 26 may be maintained at the set or predetermined speed with little change throughout a duration for which both the first and second heating operations are performed. Accordingly, heat may be supplied to the front region of the cooking chamber 12 continuously even while the cooking appliance performs the second heating operation.

For example, heating of the front region of the cooking chamber 12 is performed at a weaker level when the second heating operation is performed than when the first heating operation is performed, but the temperature in the front region of the cooking chamber 12 may continue to remain at a temperature level elevated as a result of performing the first heating operation. In other words, when the second heating operation is performed, heat supply may be concentrated on the rear surface 112 of the cavity 11 and its surrounding space, the lower region 113b of the side surface 113 of the cavity 11 and its surrounding space, and the rear region 111a of the bottom surface 111 of the cavity 11 and its surrounding space, but heat supply to the front region of the cooking chamber 12 may also continue at a level sufficient to maintain the temperature of that region.

Typically, because the convection device 20 is disposed at the rear side of the cooking chamber, a greater heat loss occurs in the front region of the cooking chamber 12, which is farther from the convection device 20, than in the rear region of the cooking chamber 12, which is closer to the convection device 20. In view of this point, this embodiment ensures that the speed of the fan 26 is maintained at the set or predetermined speed when the first and second heating operations are performed, thereby allowing heat supply to the front region of the cooking chamber 12 to be maintained at a certain level or higher. Accordingly, the cooking appliance according to this embodiment may induce thermal decomposition to occur continuously and actively in the front region of the cooking chamber 12 by allowing the temperature in the front region of the cooking chamber 12 to be continuously maintained at a temperature level elevated as a result of performing the first heating operation.

As described above, the output of the convection heater 23 is exemplified as being lower than the output of the broil heater 15 in this embodiment. Accordingly, the temperature of the cooking chamber 12 rises rapidly when the first heating operation is performed, whereas the temperature of the cooking chamber 12 when the second heating operation is performed may be maintained at a level approximately equal to the temperature at an end of the first heating operation. In addition, a high amount of heat is supplied to the front region of the cooking chamber 12 by the broil heater 15 when the first heating operation is performed, and accordingly, the temperature in the front region of the cooking chamber 12 may rise rapidly to the temperature required for performing self-cleaning. Further, a relatively lower amount of heat is supplied to the cooking chamber 12 by the convection heater 23 when the second heating operation is performed than the amount of heat supplied when the first heating operation is performed, allowing the temperature in all regions of the cooking chamber 12 to be maintained uniformly at a temperature suitable for performing self-cleaning.

Typically, as a significant heat loss occurs in the front region of the cooking chamber 12, a greater amount of heat needs to be supplied to the front region of the cooking chamber 12 so as to maintain the temperature in the front region of the cooking chamber 12 at a level similar to temperatures in the rest of the regions of the cooking chamber 12, and to effectively remove contaminants in the front region of the cooking chamber 12. In view of this point, the cooking appliance according to this embodiment allows a greater amount of heat to be supplied to the front region of the cooking chamber 12 than to the other regions of the cooking chamber 12 by ensuring that the heat supply to the front region of the cooking chamber 12 begins at an earlier time point and lasts for a longer period of time than to the other regions of the cooking chamber 12.

Moreover, an execution duration of the second heating operation is exemplified as being longer than or equal to an execution duration of the first heating operation in this embodiment. In other words, a length of the second set or predetermined time may be set longer than a length of the first set or predetermined time. As described above, as the convection heater 23 is operated instead of the broil heater 15 in the second heating operation and the output of the convection heater 23 is lower than that of the broil heater 15, more time may be needed in order for the temperature of the rear surface 112 of the cavity 11 and its surrounding space, the lower region 113b of the side surface 113 of the cavity 11 and its surrounding space, and the rear region 111a of the bottom surface 111 of the cavity 11 to rise sufficiently to the temperature required for self-cleaning than when heating the front region of the cooking chamber 12 by the first heating operation.

In view of this point, the execution duration of the second heating operation is set longer than or equal to the execution duration of the first heating operation in this embodiment. By the first and second heating operations performed in this way, the temperature in all regions of the cooking chamber 12 may be effectively maintained at a high temperature suitable for performing self-cleaning.

After the second heating operation has been performed for the second set or predetermined time as described above, the cooking appliance may perform a third heating operation (S130). When the cooking appliance performs the third heating operation, the control unit 90 may drive the broil heater 15 and the convection heater 23.

In the third heating operation, the broil heater 15 and the convection heater 23 may be driven alternately. In the third heating operation, an alternating interval between the driving of the broil heater 15 and the driving of the convection heater 23 may be set shorter than an execution duration of the first heating operation and an execution duration of the second heating operation.

For example, if the execution duration of the first heating operation and the execution duration of the second heating operation are each approximately 2 to 4 minutes, then a pattern in which after the broil heater 15 is driven for approximately 10 seconds, the convection heater 23 is driven for approximately 10 seconds, and then the broil heater 15 is driven again for approximately 10 seconds may be repeated in the third heating operation.

According to this embodiment, the third heating operation may be performed after the temperature in all regions of the cooking chamber 12 has reached a temperature suitable for performing self-cleaning as the cooking appliance has completed execution of the first and second heating operations. When the cooking appliance performs the third heating operation, the driving of the broil heater 15 and the driving of the convection heater 23 may alternate at a very short interval compared to the execution duration of the first heating operation and the execution duration of the second heating operation. The cooking appliance according to this embodiment, which performs the third heating operation in this way, may continuously maintain the temperature in all regions of the cooking chamber 12 at a temperature suitable for removing contaminants while performing the self-cleaning operation.

Further, in the third heating operation, the rotational speed of the fan 26 may be maintained at a set or predetermined speed. Accordingly, the rotational speed of the fan in the first heating operation, the rotational speed of the fan 26 in the second heating operation, and the rotational speed of the fan 26 in the third heating operation may remain identical. As a result, the temperature in the front region of the cooking chamber 12 may be maintained continuously at a temperature suitable for removing contaminants, thereby enabling thermal decomposition in the front region of the cooking chamber 12 to occur continuously and actively.

In conventional cooking appliances, an AC motor is typically applied as a fan motor for rotating the fan of a convection device. An inverter is required to adjust the rotational speed of an AC motor; however, mounting an inverter to a small AC motor for driving a fan is challenging. Therefore, adjusting the rotational speed of a fan with an AC motor applied thereto is practically impossible.

Moreover, the rotational speed of the fan rotated by the AC motor exhibits a tendency to gradually increase as the temperature of the cooking chamber rises, and exhibits a tendency to continuously fluctuate without maintaining a constant value even after that, as shown in FIG. 14. For example, the rotational speed of the fan at an initial stage of driving of the AC motor when the cooking appliance performs the self-cleaning operation is approximately 1,000 rpm, then the rotational speed of the fan increases to approximately 1,800 rpm as the temperature of the cooking chamber rises, and even after that, the rotational speed of the fan fails to maintain 1,800 rpm but keeps fluctuating.

Further, in conventional cooking appliances, when the cooking appliance raises the temperature of the cooking chamber in order to perform the self-cleaning operation, the heating device operates in a pattern in which alternating between the driving of the broil heater and the driving of the convection heater is repeated at short time intervals. In other words, in conventional cooking appliances, operations of the same type as the first and second driving operations of this embodiment are not performed, but only operations of the type similar to the third driving operation of this embodiment are performed.

Accordingly, the temperature in the front region of the cooking chamber is unlikely to rise sufficiently at an initial stage of performing the self-cleaning operation in conventional cooking appliances. This is because, in conventional cooking appliances, not only is the broil heater unable to operate sufficiently at the initial stage of performing the self-cleaning operation, but the hot air also fails to properly reach the front region of the cooking chamber due to the slow rotational speed of the fan.

Moreover, in conventional cooking appliances, because the rotational speed of the fan cannot remain constant at a speed that can allow hot air to sufficiently reach the front region of the cooking chamber, the temperature in the front region of the cooking chamber can hardly remain at a temperature suitable for removing contaminants. Accordingly, the state of removal of contaminants in the front region of the cooking chamber is likely to be poor in conventional cooking appliances.

In contrast, the cooking appliance according to embodiments disclosed herein may ensure sufficient operating time for the high-output broil heater 15 at an initial stage of performing the self-cleaning operation by performing the first heating operation at the initial stage of performing the self-cleaning operation, and simultaneously enable the rotational speed of the fan 26 to remain at a rotational speed that may allow hot air to sufficiently reach the front region of the cooking chamber 12, as shown in FIGS. 9 to 13. The cooking appliance according to embodiments disclosed herein may not only raise the temperature of the cooking chamber 12 quickly to the temperature required for performing self-cleaning, but also continuously maintain heat concentration on the front region of the cooking chamber 12, thereby enabling heat supply to the front region of the cooking chamber 12 to begin at an earlier time point and last a longer period of time than the other regions of the cooking chamber 12. Thus, the cooking appliance according to embodiments disclosed herein may effectively remove contaminants stuck to wall surfaces of the cooking chamber, particularly contaminants firmly fixed to the wall surfaces of the front region of the cooking chamber by enabling the removal of contaminants from the front region of the cooking chamber 12, which is a region where proper removal of contaminants is difficult when performing self-cleaning, to be achieved at a level equal to or higher than that of the other regions of the cooking chamber 12.

In addition, the cooking appliance of according to embodiments disclosed herein may effectively improve results of self-cleaning performance of the cooking appliance while suppressing an increase in power consumption by adjusting the operating timing of the broil heater 15 and the rotational speed of the fan 26 so that an optimal amount of heat that allows for effective thermal decomposition in the front region of the cooking chamber 12 may be supplied at an optimal time.

Embodiments disclosed herein provide a cooking appliance capable of effectively removing contaminants firmly fixed to wall surfaces of a cooking chamber.

Embodiments disclosed herein also provide a cooking appliance and a method for controlling a cooking appliance, which may improve results of self-cleaning performance of the cooking appliance while suppressing an increase in power consumption.

A method for controlling a cooking appliance according to embodiments disclosed herein may sequentially performing a first heating operation of driving a broil heater and a fan, and a second heating operation of driving a convection heater and the fan.

A method for controlling a cooking appliance according to embodiments disclosed herein may include a first heating operation of driving a broil heater and a fan, and a second heating operation of driving a convection heater and the fan. A rotational speed of the fan in the first heating operation and a rotational speed of the fan in the second heating operation may be the same.

A cooking appliance according to embodiments disclosed herein may include a cavity that forms a cooking chamber, a broil heater installed on one or a first surface of the cavity and disposed inside of the cooking chamber, a convection heater installed on another or a second surface of the cavity and disposed inside or outside of the cooking chamber, and a fan configured to blow hot air into the cooking chamber, and may include a first heating operation of driving the broil heater and the fan, and a second heating operation of driving the convection heater and the fan.

The rotational speed of the fan in the first heating operation and the rotational speed of the fan in the second heating operation may be the same. Further, in the first heating operation, the rotational speed of the fan may be maintained at a set or predetermined speed.

Moreover, in the first heating operation and the second heating operation, the rotational speed of the fan may be maintained at a set or predetermined speed. In addition, the first heating operation may be performed before the second heating operation.

An execution duration of the second heating operation may be longer than or equal to an execution duration of the first heating operation.

Further, the cooking appliance may further include a third heating operation of driving the broil heater and the convection heater. In the third heating operation, driving of the broil heater and driving of the convection heater may be performed alternately.

Furthermore, in the third heating operation, the fan may be driven and the rotational speed of the fan may be maintained at a set or predetermined speed.

Moreover, the rotational speed of the fan in the first heating operation, the rotational speed of the fan in the second heating operation, and the rotational speed of the fan in the third heating operation may be the same. In addition, in the third heating operation, an alternating interval between driving of the broil heater and driving of the convection heater may be shorter than an execution duration of the first heating operation and an execution duration of the second heating operation.

An amount of heat per unit time supplied to the cooking chamber by the first heating operation may be higher than an amount of heat per unit time supplied to the cooking chamber by the second heating operation.

A cooking appliance according to embodiments disclosed herein may include a cavity that forms a cooking chamber; a broil heater installed on one or a first surface of the cavity and disposed inside of the cooking chamber; a convection heater installed on another or a second surface of the cavity and disposed inside or outside of the cooking chamber; a fan module including a fan configured to rotate to blow hot air into the cooking chamber; and a control unit configured to control an operation of the broil heater, the convection heater, and the fan module. The control unit may sequentially perform a first heating operation of driving the broil heater and the fan, and a second heating operation of driving the convection heater and the fan.

The cooking appliance may further include a door disposed on a front side of the cavity and configured to open and close the cooking chamber.

Further, the broil heater may be installed on a top surface of the cavity. The convection heater and the fan module may be installed on a rear surface of the cavity.

The fan module may include a BLDC motor configured to maintain a speed of the fan at a set speed in a process of performing the first heating operation and the second heating operation. Further, the fan module may be configured to rotate the fan in forward and reverse directions.

Moreover, an amount of heat per unit time supplied to the cooking chamber by the broil heater may be higher than an amount of heat per unit time supplied to the cooking chamber by the convection heater.

Embodiments disclosed herein enable removal of contaminants from a front region of the cooking chamber, which is a region where proper removal of contaminants is difficult when performing self-cleaning, to be achieved at a level equal to or higher than that of the other regions of the cooking chamber by allowing heat supply to the front region of the cooking chamber to begin at an earlier time point and last a longer period of time than the other regions of the cooking chamber.

The cooking appliance and the method for controlling a cooking appliance according to embodiments disclosed herein may effectively remove contaminants stuck to the wall surfaces of the cooking chamber, particularly contaminants firmly fixed to the wall surfaces of the front region of the cooking chamber.

Further, embodiments disclosed herein may effectively improve results of self-cleaning performance of the cooking appliance while suppressing an increase in power consumption by adjusting an operating timing of the broil heater and a rotational speed of the fan so that an optimal amount of heat that allows for effective thermal decomposition in the front region of the cooking chamber may be supplied at an optimal time.

Embodiment have been described with reference to the embodiments shown in the drawings, which, however, are merely illustrative, and those having ordinary skill in the art to which the present disclosure pertains will appreciate that various modifications and other equivalent embodiments are possible therefrom. Therefore, the true technical scope of protection according to embodiments disclosed herein shall be determined by the following claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for controlling a cooking appliance having a self-cleaning operation, the cooking appliance comprising a cavity that forms a cooking chamber, a broil heater installed on a first surface of the cavity and disposed inside of the cooking chamber, a convection heater installed on a second surface of the cavity and disposed inside or outside of the cooking chamber, and a fan configured to operate to blow hot air into the cooking chamber, the method comprising:
in the self-cleaning operation, performing a first heating operation of driving the broil heater and the fan; and
then performing a second heating operation of driving the convection heater and the fan.

2. The method of claim 1, wherein a rotational speed of the fan in the first heating operation and a rotational speed of the fan in the second heating operation are the same.

3. The method of claim 1, wherein, in the first heating operation, a rotational speed of the fan is maintained at a predetermined speed.

4. The method of claim 1, wherein, in the first heating operation and the second heating operation, a rotational speed of the fan is maintained at a predetermined speed.

5. The method of claim 1, wherein the first heating operation is performed before the second heating operation, and wherein an execution duration of the second heating operation is longer than or equal to an execution duration of the first heating operation.

6. The method of claim 1, further comprising:
performing a third heating operation of driving the broil heater and the convection heater.

7. The method of claim 6, wherein, in the third heating operation, driving of the broil heater and driving of the convection heater are performed alternately.

8. The method of claim 7, wherein, in the third heating operation, the fan is driven, and a rotational speed of the fan is maintained at a predetermined speed.

9. The method of claim 8, wherein a rotational speed of the fan in the first heating operation, a rotational speed of the fan in the second heating operation, and the rotational speed of the fan in the third heating operation are the same.

10. The method of claim 7, wherein, in the third heating operation, an alternating interval between the driving of the broil heater and the driving of the convection heater is shorter than an execution duration of the first heating operation and an execution duration of the second heating operation.

11. The method of claim 1, wherein an amount of heat per unit time supplied to the cooking chamber by the first heating operation is higher than an amount of heat per unit time supplied to the cooking chamber by the second heating operation.

12. A cooking appliance having a self-cleaning operation, comprising:
a cavity that forms a cooking chamber;
a broil heater installed on a first surface of the cavity and disposed inside of the cooking chamber;
a convection heater installed on a second surface of the cavity and disposed inside or outside of the cooking chamber;
a fan module including a fan configured to rotate to blow hot air into the cooking chamber; and
a control unit configured to control operations of the broil heater, the convection heater, and the fan module, wherein, in the self-cleaning operation, the control unit sequentially performs a first heating operation of driving the broil heater and the fan and a second heating operation of driving the convection heater and the fan.

13. The cooking appliance of claim 12, further comprising:
a door disposed on a front side of the cavity and configured to open and close the cooking chamber, wherein the first surface is a top surface of the cavity, wherein the second surface is a rear surface of the cavity, and wherein both of the convection heater and the fan module are installed on the rear surface of the cavity.

14. The cooking appliance of claim 12, wherein the fan module comprises a BLDC motor provided to maintain a speed of the fan at a set predetermined speed in the first heating operation and in the second heating operation.

15. The cooking appliance of claim 12, wherein the fan module is configured to rotate the fan in forward and reverse directions.

16. The cooking appliance of claim 12, wherein an amount of heat per unit time supplied to the cooking chamber by the broil heater is higher than an amount of heat per unit time supplied to the cooking chamber by the convection heater.

17. A method for controlling a cooking appliance having a self-cleaning operation, the cooking appliance comprising a cavity that forms a cooking chamber, a broil heater installed on a first surface of the cavity and disposed inside of the cooking chamber, a convection heater installed on a second surface of the cavity and disposed inside or outside of the cooking chamber, and a fan configured to operate to blow hot air into the cooking chamber, the method comprising:
in the self-cleaning operation, sequentially performing:
a first heating operation of driving the broil heater and the fan for a first predetermined period of time;
a second heating operation of driving the convection heater and the fan for a second predetermined period of time; and
a third heating operation of driving the broil heater and the convection heater alternately each for a third predetermined period of time.

18. The method of claim 17, wherein the third predetermined period of time is shorter than the first predetermined period of time and the second predetermined period of time.

19. The method of claim 17, wherein a rotational speed of the fan in the first heating operation and a rotational speed of the fan in the second heating operation are the same.

20. The method of claim 17, wherein, in the first heating operation and the second heating operation, a rotational speed of the fan is maintained at a predetermined speed.
